(19) United States
(12) Patent Application Publication
(10) Pub. No.: US 2018/0151878 A1
(43) Pub. Date: May 31, 2018

(54) ANODE MATERIAL FOR LITHIUM-ION BATTERY AND ANODE FOR LITHIUM-ION BATTERY

(71) Applicants: TOYOTA JIDOSHA KABUSHIKI KAISHA, Toyota-shi (JP); Shanghai Jiao Tong University, Shanghai (CN)

(72) Inventors: Li YANG, Shanghai (CN); Zhengxi ZHANG, Shanghai (CN); Jun HUANG, Shanghai (CN); Qinghua TIAN, Shanghai (CN); Hideyuki KOGA, Numazu-shi (JP)

(73) Assignees: TOYOTA JIDOSHA KABUSHIKI KAISHA, Toyota-shi (JP); Shanghai Jiao Tong University, Shanghai (CN)

(21) Appl. No.: 15/808,348

(22) Filed: Nov. 9, 2017

(30) Foreign Application Priority Data
Nov. 29, 2016 (CN) 201611072844.2

(51) Int. Cl. H01M 4/485; H01M 10/0525; C01G 23/00; C01G 29/00

(52) U.S. Cl. CPC H01M 4/485; H01M 10/0525; H01M 2004/027; C01G 29/006; C01G 29/00; C01G 23/002

(57) ABSTRACT

The present invention relates to an anode material for lithium-ion batteries. The anode material for lithium-ion batteries is represented by the molecular formula: MₓN_{y}Ti_{z}O_{(x+3y+4z)/2}, where: 0≤x≤8, 1≤y≤8, and 1≤z≤8; M is an alkali metal selected from the group consisting of Li, Na, and K; and N is a group V_{A} element selected from the group consisting of P, Sb, and Bi or a rare earth metal selected from the group consisting of Nd, Pm, Sm, Eu, Yb, and La. The anode material of the present invention has a delithiation potential of 0.8 to 1.2 V vs. Li⁺/Li, and has a better potential plateau, better cycle performance, and better output-input properties, than a titanium-based anode material.

### BACKGROUND OF THE INVENTION

The present invention relates to a new anode material for lithium-ion batteries and an anode for lithium-ion batteries comprising the anode material, particularly to an anode material having a delithiation potential of 0.8 to 1.2 V vs. Li⁺/Li.

Conventionally, graphite has often been used as an anode material in commercialized lithium-ion batteries. However, graphite has a low charge/discharge plateau potential (0.1 V vs. Li⁺/Li) and poor overcharge tolerance, which results in the occurrence of a side reaction such as reductive decomposition of an electrolyte solution. A solid electrolyte interface (SEI) film formed during initial charge tends to be decomposed during high-temperature operation, and the long-term stability of the film cannot be secured. Lithium dendrite is easily generated, and the lithium dendrite adversely affects the performance of a lithium-ion battery. For example, since a titanate such as Li₄Ti₅O₁₂ has a delithiation potential of about 1.55 V Li⁺/Li and forms neither the SEI film nor lithium dendrite, the safety and the like of the battery are significantly improved, but there is a problem of voltage reduction of the whole battery.

An anode material having a delithiation potential of 0.8 to 1.2 V has attracted attention, because the generation of lithium dendrite can be prevented since the charge/discharge potential thereof is sufficiently high, and the voltage of the whole battery is not significantly reduced. Further, although there are not many reports on titanium-based anode materials having a delithiation potential of 0.8 to 1.2 V, all the materials have specific problems. For example, MLi₂Ti₆O₁₄, which is a titanium-based material (where M=Ba, Sr, Pb, 2Na, or 2K), and the like have been reported (J. Electroanal. Chem., 717, 10-16, 2014. J. Power Sources, 293, 33-41, 2015. Electrochim. Acta, 173, 595-606, 2015. J. Power Sources, 296, 276-281, 2015. Inorg. Chem. 2010, 49, 2822-2826). As compared with Li₄Ti₅O₁₂, Na₂Li₂Ti₆O₁₄ has a low charge/discharge plateau potential (about 1.25 V) and a short potential plateau as well as material properties of a low electric conductivity and a low lithium-ion diffusion coefficient, and thus has poor output-input properties. The reported Li(V_{0.5}Ti_{0.5})S₂ (Nat. Commun., 7, 1-7, 2016) material experiences a complicated production process that requires severe conditions such as vacuum and high pressure, and in addition it has poor cyclicity.

### SUMMARY OF THE INVENTION

In the present invention, in order to prevent safety problems such as potential lithium dendrite in a commercialized graphite anode for lithium-ion batteries and to solve the disadvantage of a conventional anode material having a delithiation potential of 0.8 to 1.2 V vs. Li⁺/Li, a new anode material having a delithiation potential of 0.8 to 1.2 V vs. Li⁺/Li has been researched and developed.

An anode material for lithium-ion batteries according to the present invention is represented by a molecular formula: MₓN_{y}Ti_{z}O_{(x+3y+4z)/2}, where: 0≤x≤8, 1≤y≤8, and 1≤z≤8; M is an alkali metal selected from the group consisting of Li, Na, and K; and N is a group V_{A} element selected from the group consisting of P, Sb, and Bi or a rare earth metal selected from the group consisting of Nd, Pm, Sm, Eu, Yb, and La.

The anode material for lithium-ion batteries according to the present invention is preferably configured such that 0≤x≤5, 1≤y≤5, and 1≤z≤5.

The anode material for lithium-ion batteries according to the present invention is preferably configured such that M is Li or Na, and N is Bi or Eu.

The anode material for lithium-ion batteries according to the present invention is preferably configured such that the anode material is LiEuThiO₄, NaBiTiO₄, LiBiTiO₄, or Bi₄Ti₃O₁₂.

The anode material for lithium-ion batteries according to the present invention is preferably configured such that the anode material has a particle size of 0.1 to 20 μm.

In accordance with the present invention, an anode for lithium-ion batteries is provided that includes the above described anode material for lithium-ion batteries.

The anode material according to the present invention has a better potential plateau, better cycle performance, and better magnification properties, than a conventional titanium-based anode material having a delithiation potential of 0.8 to 1.2 V.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is an XRD pattern of the anode material LiEuTiO₄ of Example 1;

FIG. 2 is an SEM view of the anode material LiEuTiO₄ of Example 1;

FIG. 3 is a charge/discharge graph of the anode material LiEuTiO₄ of Example 1;

FIG. 4 is a cycle characteristic diagram of the anode material LiEuTiO₄ of Example 1;

FIG. 5 is an XRD pattern of the anode material NaBiTiO₄ of Example 2;

FIG. 6 is an SEM view of the anode material NaBiTiO₄ of Example 2;

FIG. 7 is a charge/discharge graph of the anode material NaBiTiO₄ of Example 2;

FIG. 8 is an XRD pattern of the anode material LiBiTiO₄ of Example 3;

FIG. 9 is an SEM view of the anode material LiBiTiO₄ of Example 3;

FIG. 10 is a charge/discharge graph of the anode material LiBiTiO₄ of Example 3;

FIG. 11 is an XRD pattern of the anode material Bi₄Ti₃O₁₂ of Example 4;

FIG. 12 is an SEM view of the anode material Bi₄Ti₃O₁₂ of Example 4; and

FIG. 13 is a charge/discharge graph of the anode material Bi₄Ti₃O₁₂ of Example 4.

### DESCRIPTION OF THE PREFERRED EMBODIMENTS

The anode material compound according to the present invention is represented by the molecular formula: MₓN_{y}Ti_{z}O_{(x+3y+4z)/2}, where 0≤x≤8, 1≤y≤8, and 1≤z≤8; M is an alkali metal selected from the group consisting of Li, Na, and K; and N is a group V_{A} element selected from the group consisting of P, Sb, and Bi or a rare earth metal selected from the group consisting of Nd, Pm, Sm, Eu, Yb, and La.

Preferably, 0≤x≤5, 1≤y≤5, and 1≤z≤5.

Preferably, M is Li or Na, and N is Bi or Eu.

The anode materials obtained in specific examples of the present invention are crystalline particles in a sheet form or in an aggregated form, the size of which is 0.1 to 20 μm, preferably 0.2 to 10 μm. However, the form and the size of particles of the anode material of the present invention are not specially required, as long as the particle conditions as a common anode raw material for lithium batteries are satisfied.

The anode material of the present invention can be synthesized by three methods of a solid phase method, a solvothermal method, and a sol-gel method. The M source used as a reaction raw material is an alkali metal hydroxide, carbonate, oxalate, nitrate, acetate, or sulfate. The titanium source is, for example, titanium dioxide, titanium tetrachloride, tetrabutyl titanate, or isopropyl titanium. The N source is an oxide, a nitrate, a carbonate, an oxalate, a sulfate, or a citrate, of group VA elements or rare earth metals.

Conventional Solid Phase Reaction Method:

The M source, the titanium source, and the N source are mixed at a stoichiometric mixing ratio based on the molecular formula of a desired anode material compound (for example, by a method of ball milling or grinding), and the mixture is then subjected to heat treatment (for example, for 2 to 24 hours at 600 to 1200° C.). Then, ion exchange is optionally performed in the condition of a molten salt (for 3 to 24 hours at 300 to 700° C.) (For example, in the case of synthesizing LiEuTiO₄, since a Li element easily volatilizes in high temperature treatment, NaEuTiO₄ is first obtained using a Na element, and then it is subjected to ion exchange with a molten Li salt (for example, LiNO₃) to thereby obtain LiEuTiO₄. Specifically, refer to the production process in examples to be described below.). Finally, the product is washed (washed with water or alcohol) and dried (for 6 to 24 hours at 60 to 150° C.)

Solvothermal Method:

The M source, the titanium source, and the N source are dissolved and stirred (for 0.5 to 6 hours) in a solvent (for example, water, ethanol, acetic acid, aqueous ammonia, nitric acid, or sodium hydroxide) at a stoichiometric mixing ratio based on the molecular formula of a desired anode material compound to thereby disperse and dissolve the reaction raw materials. Then, the resulting solution is put, for example, into a stainless steel reaction kettle and subjected to heat treatment (for 12 to 48 hours at 120 to 220° C.). Finally, a precipitated product is collected, washed (with water or alcohol), and dried (for 6 to 24 hours at 60 to 150° C.)

Sol-Gel Reaction Method:

An alkali metal salt (for example, a hydroxide, a carbonate, an oxalate, a nitrate, an acetate, a sulfate, or the like) is dissolved and stirred in a solvent (for example, water, ethanol, acetic acid, aqueous ammonia, nitric acid, or a solution of sodium hydroxide or the like). A group VA element or a rare earth metal (for example, an oxide, a nitrate, a carbonate, an oxalate, a sulfate, a citrate, or the like) is dissolved in a solvent (for example, water, ethanol, acetic acid, aqueous ammonia, nitric acid, or the like), and the resulting solution is then added to the alkali metal salt solution with stirring. Then, the titanium source (for example, titanium dioxide, titanium tetrachloride, tetrabutyl titanate, isopropyl titanium, or the like) is added to the mixture, followed by adding water thereto. The liquid mixture is stirred for 2 hours and then aged for 10 to 48 hours at 80 to 120° C., and an excess solvent is removed by evaporation. The resulting dry gel (a metal oxide or hydroxide or a blend thereof) is incinerated for 2 to 15 hours at 500 to 1,200° C.

Measurement of Anode Material

The crystal structure and morphology of MₓN_{y}Ti_{z}O_{(x+3y+4z)/2} material were analyzed by XRD and SEM, and the electrochemical performance when it is used as an anode material for lithium-ion batteries was measured.

Electrochemical Performance Measurement Conditions:

In the measurement of a battery, the anode material is used as a working electrode, and metallic lithium is used as a counter electrode.

Electrolyte solution: diethyl carbonate/dimethyl carbonate=1/1, 1 M LiPF₆; temperature: 25° C.;

Binder: carboxymethyl cellulose (CMC);

Component ratio of electrode material: anode material (active material): conductive acetylene black: CMC=70:20:10;

Diaphragm: PE polymer diaphragm;

Voltage range: 0.01 to 3.0 V vs. Li⁺/Li.

### EXAMPLES

### Example 1. LiEuTiO₄

Production Method: Solid Phase Reaction Method

In a mortar, 0.13 mol of Na₂C₂O₄, 0.2 mol of TiO₂, and 0.1 mol of Eu₂O₃ were ground and mixed at a stoichiometric mixing ratio as reaction raw materials. Then, the resulting mixture was subjected to heat treatment (for 12 hours at 900° C.) to thereby obtain 0.2 mol of NaEuTiO₄. The ion exchange between NaEuTiO₄ and lithium ions was performed in 0.26 mol of molten LiNO₃ (for 12 hours at 350° C.). Then, the resulting product LiEuTiO₄ was washed (washed with water) and dried in an oven (at 80° C.)

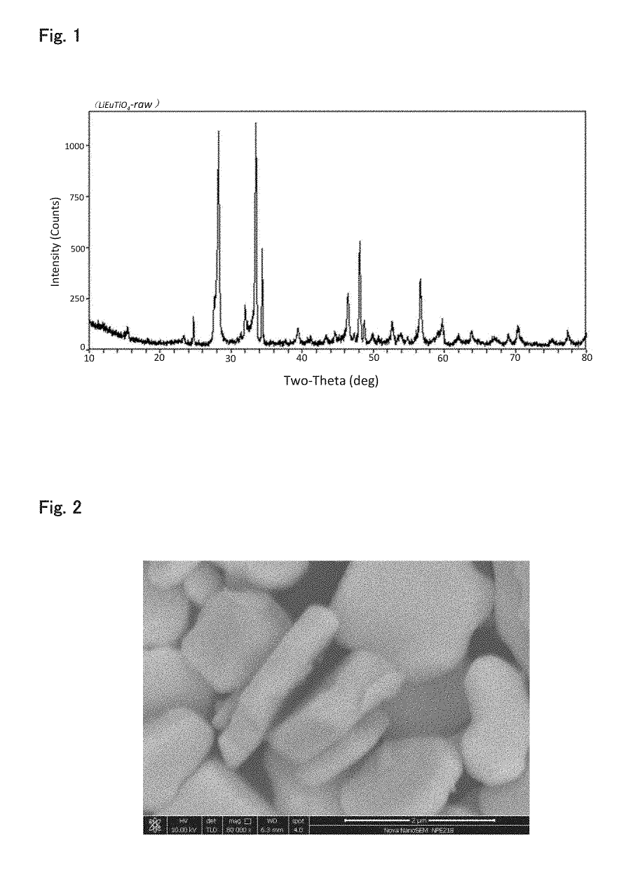

As shown in the X-ray diffraction pattern (XRD pattern, FIG. 1) of the product, LiEuTiO₄ that was excellent in crystallinity was successfully synthesized.

As shown in the scanning electron microscope view (SEM view, FIG. 2) of LiEuTiO₄, the product was in a sheet form and had a size of about 2 μm.

Electrochemical Performance:

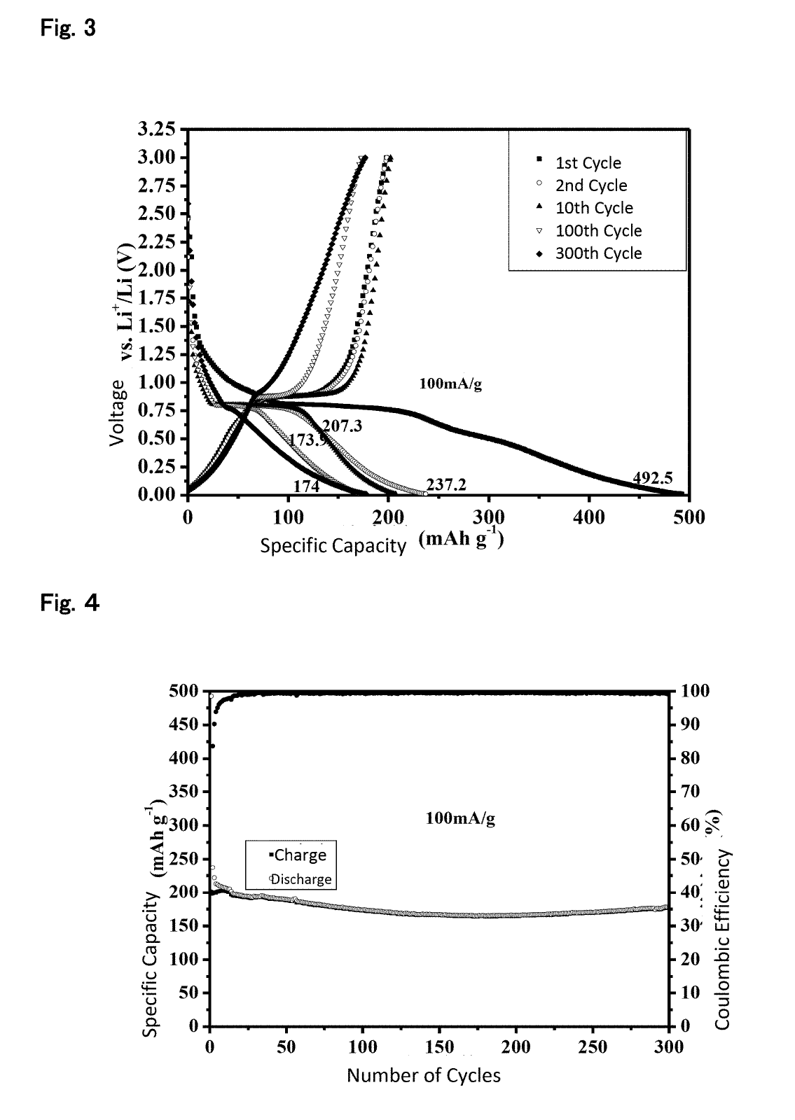

The electrochemical performance of LiEuTiO₄ was measured, and the plateau in the charge/discharge graph was about 0.8 V. Referring to FIGS. 3 and 4, the charge/discharge current density was 100 mA/g.

The charge/discharge graph of LiEuTiO₄ has one potential plateau of 0.8 V vs Li⁺/Li, which is in agreement with the target of the invention of the present application. As shown in FIG. 3, the discharge specific capacity of LiEuTiO₄ was stably maintained at 170 mAh g⁻¹ after 100 cycles, and the coulombic efficiency was about 100% after 20 cycles.

### Example 2. NaBiTiO₄

Method: Solid Phase Reaction Method

In a mortar, 0.1 mol of Na₂C₂O₄, 0.2 mol of TiO₂, and 0.1 mol of Bi₂O₃ were ground and mixed at a stoichiometric mixing ratio as reaction raw materials. Then, the resulting mixture was subjected to heat treatment (for 12 hours at 800° C.) to thereby obtain 0.2 mol of NaBiTiO₄. The resulting product NaBiTiO₄ was washed (washed with water) and dried in an oven (at 80° C.)

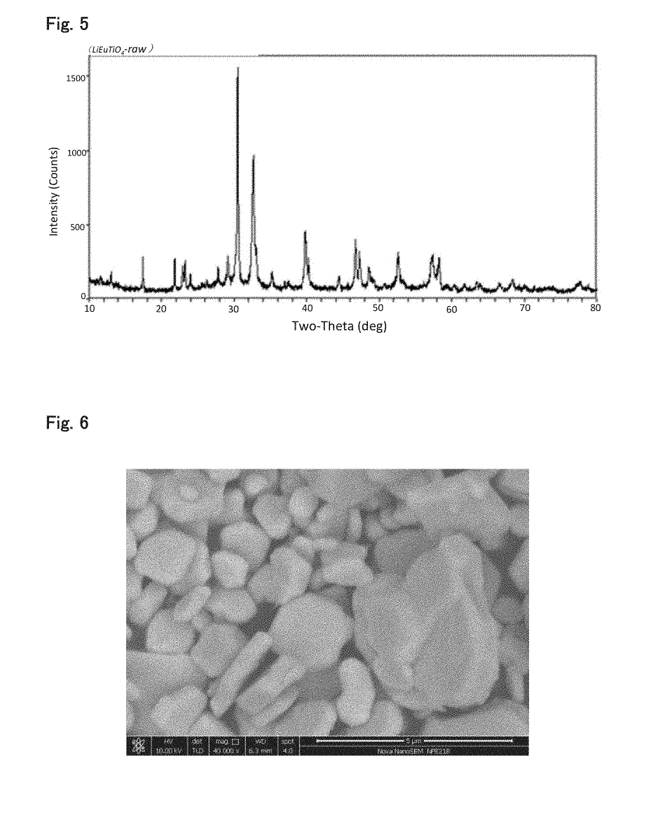

As shown in the XRD pattern (FIG. 5), NaBiTiO₄ that was excellent in crystallinity was successfully synthesized.

As shown in the SEM view (FIG. 6), the product was in a sheet form and had a micron-level size.

Electrochemical Performance:

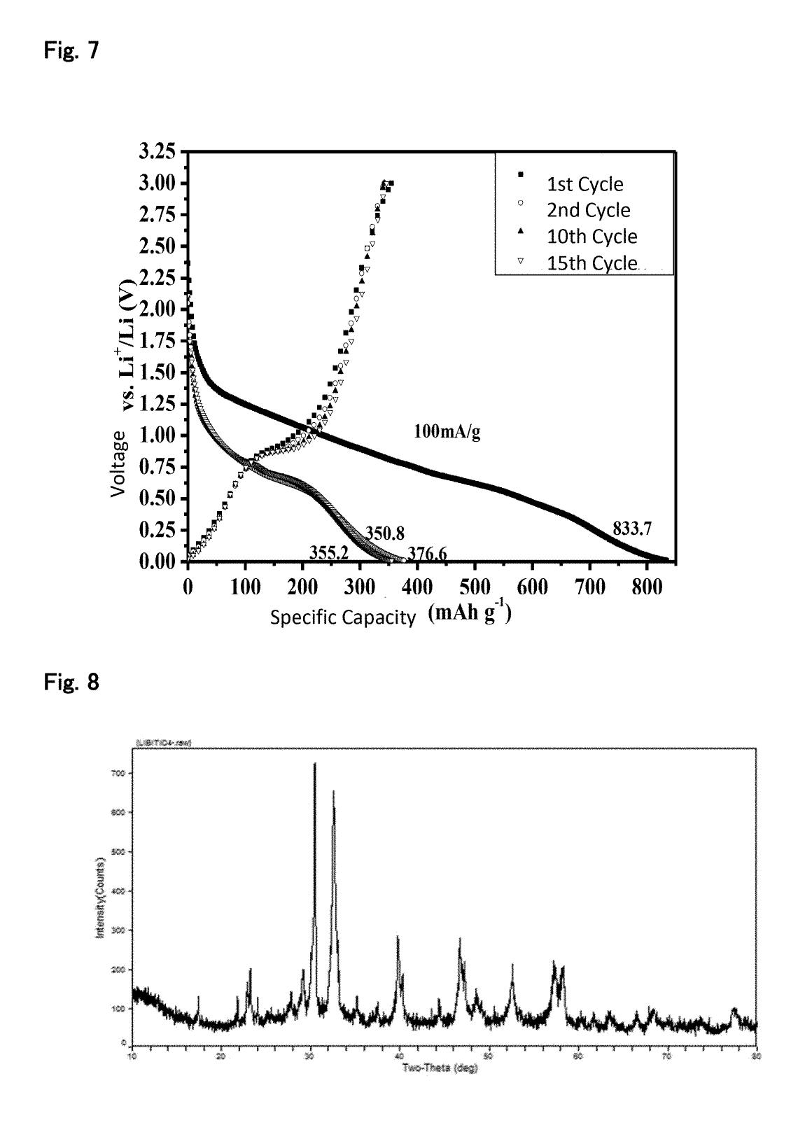

As shown in the charge/discharge graph (FIG. 7) of NaBiTiO₄, it has one potential plateau of 0.8 V vs Li⁺/Li. The specific capacity of NaBiTiO₄ is maintained at 355 mAh g⁻¹ after 10 cycles.

### Example 3. LiBiTiO₄

Method: Solid Phase Reaction Method

In a mortar, 0.13 mol of Na₂C₂O₄, 0.2 mol of TiO₂, and 0.1 mol of Bi₂O₃ were ground and mixed at a stoichiometric mixing ratio as reaction raw materials. Then, the resulting mixture was subjected to heat treatment (for 12 hours at 800° C.) to thereby obtain 0.2 mol of NaBiTiO₄. The ion exchange between NaBiTiO₄ and lithium ions was performed in 0.26 mol of molten LiNO₃ (for 12 hours at 350° C.). Then, the resulting product LiBiTiO₄ was washed (washed with water) and dried in an oven (at 80° C.)

As shown in the XRD pattern (FIG. 8), LiBiTiO₄ was successfully synthesized.

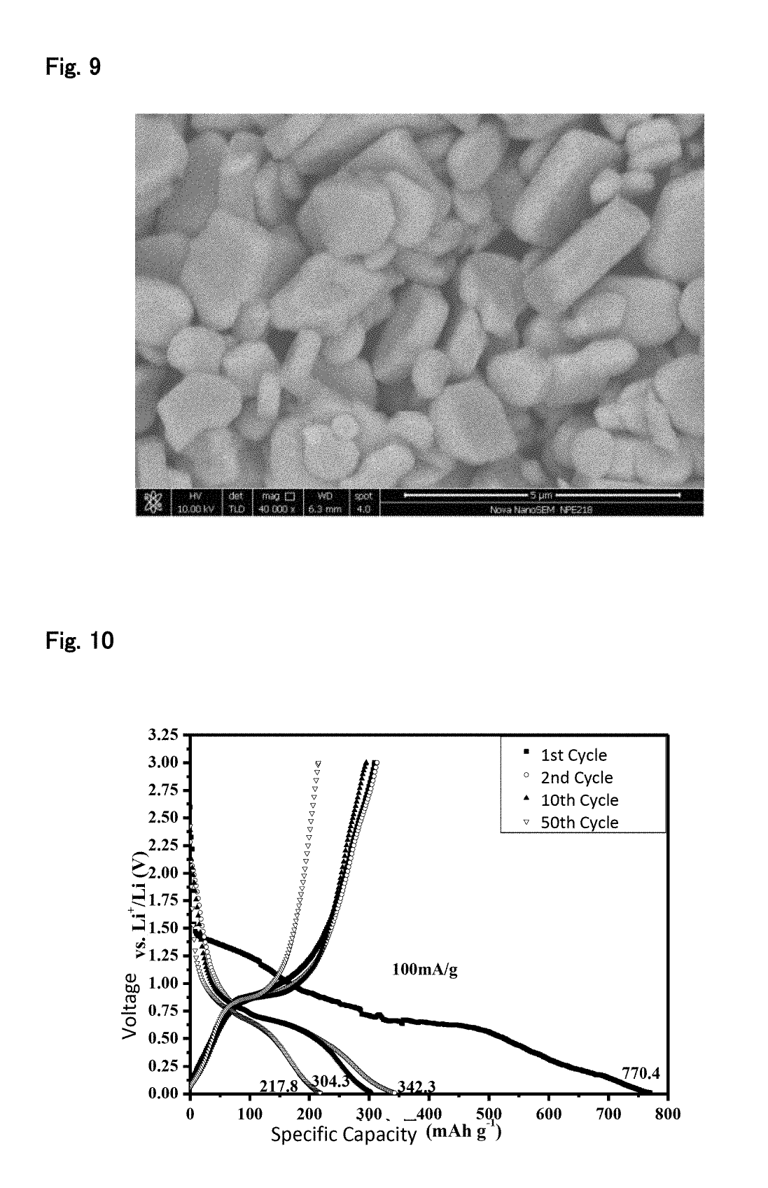

As shown in the SEM view (FIG. 9), the product was in a sheet form and had a size of 1 to 2 μm.

Electrochemical Performance:

As shown in the charge/discharge graph (FIG. 10) of LiBiTiO₄, it has one potential plateau of 0.8 V vs Li⁺/Li. The specific capacity of LiBiTiO₄ is maintained at 217.8 mAh g⁻¹ after 50 cycles.

### Example 4. Bi₄Ti₃O₁₂

Method: Hydrothermal Method (Solvothermal Method)

Each of 0.1 mol of bismuth nitrate and 0.075 mol of isopropyl titanium was put into 100 mL of water, and then a KOH solution was added thereto until the pH value increased to 12. An ultrasonic wave was applied to the solution obtained in this way for 30 minutes, and then the solution was put into a hydrothermal reaction kettle and heated for 24 hours at 180° C. Finally, the resulting precipitate was washed with water and then dried with 80° C. air.

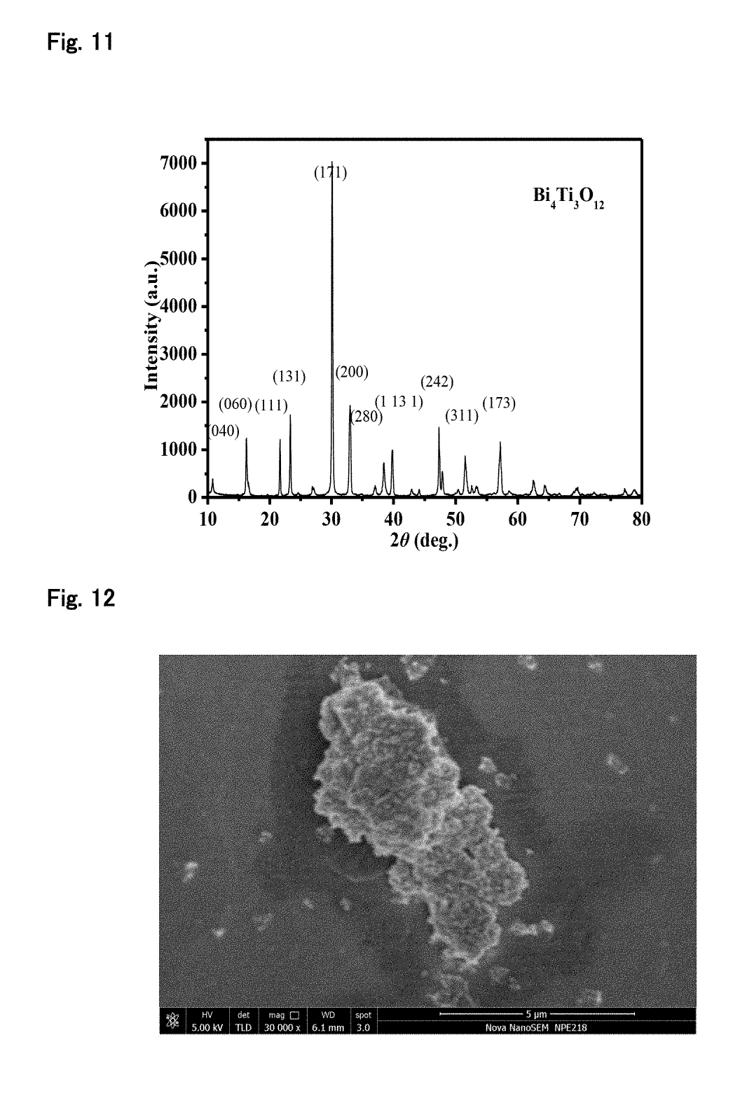

As shown in the XRD pattern (FIG. 11) of the product, Bi₄Ti₃O₁₂ was successfully synthesized.

As shown in the SEM view (FIG. 12) of the product, the product has a sample size of about 300 to 500 nm and is aggregated.

Electrochemical Performance:

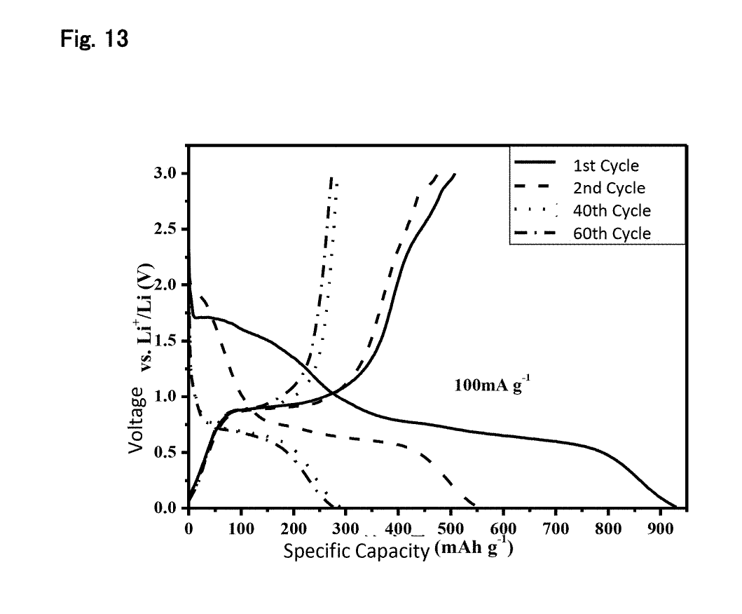

As shown in the charge/discharge graph (FIG. 13) of Bi₄Ti₃O₁₂, it has one potential plateau of 0.8 V vs Li⁺/Li. The specific capacity of Bi₄Ti₃O₁₂ is maintained at 275.8 mAh g⁻¹ after 60 cycles.

### Comparative Example 1: Na₂Li₂Ti₆O₁₄ (J. Power Sources, 293, 33-41, 2015)

The delithiation potential is 1.25 V, and the plateau is short and the plateau capacity is only about 80 mAh g⁻¹. Further, the discharge specific capacity after 30 cycles was about 175 mAh g⁻¹.

### Comparative Example 2: MLi₂Ti₆O₁₄ (M=Sr, Ba, or 2Na) (Inorg. Chem. 2010, 49, 2822-2826)

The plateau potential was about 1.5 V, the specific capacity was low, and the first discharge specific capacity was about 120 to 160 mAh g⁻¹.

1. An anode material for lithium-ion batteries, the anode material being represented by a molecular formula: MₓN_{y}Ti_{z}O_{(x+3y+4z)/2}, where:
0≤x≤8, 1≤y≤8, and 1≤z≤8;
M is an alkali metal selected from the group consisting of Li, Na, and K; and
N is a group V_{A} element selected from the group consisting of P, Sb, and Bi or a rare earth metal selected from the group consisting of Nd, Pm, Sm, Eu, Yb, and La.

2. The anode material for lithium-ion batteries according to claim 1, wherein 0≤x≤5, 1≤y≤5, and 1≤z≤5.

3. The anode material for lithium-ion batteries according to claim 1, wherein M is Li or Na, and N is Bi or Eu.

4. The anode material for lithium-ion batteries according to claim 1, wherein the anode material is LiEuTiO₄, NaBiTiO₄, LiBiTiO₄, or Bi₄Ti₃O₁₂.

5. The anode material for lithium-ion batteries according to claim 1, wherein the anode material has a particle size of 0.1 to 20 μm.

6. An anode for lithium-ion batteries comprising the anode material for lithium-ion batteries according to claim 1 as an active material.
